(19) United States
(12) Patent Application Publication
(10) Pub. No.: US 2025/0208027 A1
(43) Pub. Date: Jun. 26, 2025

(54) TEST CHAMBER AND CONTROL METHOD

(71) Applicant: Weiss Technik GmbH, Reiskirchen (DE)

(72) Inventors: Yannik Zahrt, Rabenau (DE); David Blaufelder, Giessen (DE); Christian Haack, Marburg (DE)

(21) Appl. No.: 18/987,628

(22) Filed: Dec. 19, 2024

(30) Foreign Application Priority Data
Dec. 20, 2023 (EP) 23218516.5

(51) Int. Cl. G01N 17/00; F25B 9/00

(52) U.S. Cl. CPC G01N 17/002; F25B 9/008; F25B 2600/2513

(57) ABSTRACT

A method for conditioning air in a test space of a test chamber and a test chamber, the test space being configured to be sealed from an environment and temperature-insulated, a cooling device of a temperature control device of the test chamber, which comprises a cooling circuit with carbon dioxide as a refrigerant, a heat exchanger in the test space, a low-pressure compressor, and a high-pressure compressor, a gas cooler, and an expansion valve downstream of the low-pressure compressor in a flow direction of the refrigerant, being used to establish a temperature in a temperature range of −20° C. to +180° C. within the test space, a control device of the test chamber being used to control the temperature. Another cooling circuit of the cooling device with another refrigerant, the heat exchanger in the test space, another compressor, another heat exchanger and another expansion valve is used to establish the temperature.

### CROSS-REFERENCE TO RELATED APPLICATIONS

This patent application claims priority to European Patent Application No. 23218516.5 filed on Dec. 20, 2023, the contents of which are incorporated herein by reference in its entirety for all purposes.

### TECHNICAL FIELD

This disclosure relates to a test chamber, in particular a climate chamber, for conditioning air and to a method for conditioning air in a test space of a test chamber for receiving test material, the test space being configured to be sealed from an environment and temperature-insulated, a cooling device of a temperature control device of the test chamber, which comprises a cooling circuit with carbon dioxide as a refrigerant, a heat exchanger in the test space, a low-pressure compressor, and a high-pressure compressor, a gas cooler, and an expansion valve downstream of the low-pressure compressor in a flow direction of the refrigerant, being used to establish a temperature in a temperature range of −20° C. to +180° C. within the test space, a control device of the test chamber being used to control the temperature in the test space.

### BACKGROUND

Test chambers of this kind are regularly used to test physical and/or chemical properties of objects, in particular devices. For example, there are known temperature test cabinets or climatic test cabinets within which temperatures in a range from −70° C. to +180° C. can be set. In the case of climatic test cabinets, desired climatic conditions can be additionally set, to which the device or the test material is then exposed over a defined period of time. The temperature of a test space containing the test material is regularly controlled in an air circulation duct within the test space. The air circulation duct forms an air treatment space in the test space, in which heat exchangers for heating or cooling the air flowing through the air circulation duct or the test space are disposed. A fan or a ventilator aspirates the air in the test space and guides it through the air circulation duct to the respective heat exchangers. The test material can thus be temperature-controlled or exposed to a defined change in temperature. During a test interval, the temperature can change, for example, between a maximum temperature and a minimum temperature of the test chamber. A test chamber of this kind is known from EP 0 344 397 A2, for example.

The refrigerant used in a cooling circuit should have a relatively low CO₂ equivalent, i.e., a relative global warming potential (GWP) should be as low as possible in order to avoid indirect damage to the environment by the refrigerant upon release. It is therefore also known for carbon dioxide (CO₂) to be used as a pure-substance refrigerant. Carbon dioxide is available at low cost, is non-flammable and is essentially environmentally neutral with a GWP of 1. Carbon dioxide has a freezing temperature or a triple point of −56.6° C., which makes it impossible to achieve lower temperatures with carbon dioxide alone.

Furthermore, there are known cooling devices which are configured as what is referred to as booster systems. In a cooling circuit of said cooling devices, a high-pressure compressor is always connected in series downstream of a low-pressure compressor, so the refrigerant is compressed in stages with the low-pressure compressor and then with the high-pressure compressor. Due to the high demands on temperature control within the temperature range of the test space, the load requirement frequently fluctuate during operation of the test chamber. Hence, the cooling capacity generated by the compressors and the expansion valve has to be infinitely variable. Nevertheless, it is desirable for the compressors to not be switched on and off frequently in order to extend the service life of the compressors.

Since carbon dioxide as a refrigerant has a very high volumetric cooling capacity, a very high cooling capacity is provided by the cooling circuit even when using compressors with a very low stroke volume flow. In addition, a pressure range of cooling circuits with carbon dioxide as the refrigerant is very high (up to 120 bar) in transcritical operation, which is why the components required to form the cooling circuit are comparatively expensive. Moreover, cooling circuits of this kind have a complex structure, which requires a large installation space. Up to now, the use of cooling circuits of this kind with carbon dioxide as the refrigerant has therefore only been sensible for systems or test chambers with a correspondingly high cooling capacity and thus a comparatively large test space or large device dimensions. Economic use in comparatively small systems or test chambers with a small test space volume, for example 25 liters, is not yet possible.

Furthermore, there is the problem that it is hardly possible to establish very low temperatures, e.g., <−50° C., for a use of carbon dioxide as a refrigerant or a large portion of carbon dioxide in the refrigerant. This would require using a refrigerant that is less environmentally friendly and/or flammable (A3) or highly flammable (A2L). A refrigerant is flammable in particular if it falls under fire class C according to European standard EN2 or DIN 378 classes A2, A2L and A3 in their latest version at the priority date.

### SUMMARY

Hence, the object of the present disclosure is to propose a method for conditioning air in a test space of a test chamber and a test chamber which enable an environmentally friendly operation of the test chamber even at low temperatures.

This object is attained by a method having the features described herein and a test chamber having the features described herein.

In the method according to the disclosure for conditioning air in a test space of a test chamber, in particular a climate chamber, for receiving test material, the test space being configured to be sealed from an environment and temperature-insulated, a cooling circuit of a temperature control device of the test chamber, which comprises a cooling circuit with carbon dioxide as a refrigerant, a heat exchanger in the test space, a low-pressure compressor, and a high-pressure compressor, a gas cooler, and an expansion valve downstream of the low-pressure compressor in a flow direction of the refrigerant, is used to establish a temperature in a temperature range of −20° C. to +180° C. within the test space, a control device of the test chamber being used to control the temperature in the test space, wherein another cooling circuit of cooling device with another refrigerant, the heat exchanger in the test space, another compressor, another heat exchanger and another expansion valve is used to establish the temperature within the test space.

In the method according to the disclosure, heat exchange with an environment of the test space is largely avoided by insulating the side walls, floor walls and ceiling walls. The heat exchanger is connected to the cooling circuit or integrated into it in such a manner that refrigerant circulating in the cooling circuit flows through the heat exchanger. The heat exchanger of the cooling circuit is disposed within the test space or in an air treatment space of the test space, so air in the test space is conditioned or temperature-controlled via the heat exchanger. The gas cooler is also integrated into the cooling circuit and is formed by a heat exchanger. The gas cooler is disposed downstream of the high-pressure compressor in the cooling circuit, the compressed refrigerant, which is under high pressure after compression and is essentially in gaseous or steam form or wet steam, being able to condense in the gas cooler or condenser and then essentially being in a liquid state of aggregation. It is also possible that the gaseous refrigerant does not condense in the gas cooler and leaves the gas cooler essentially in a gaseous state. The refrigerant is then only heated and is above the critical point (supercritical fluid). The gas cooler or the heat exchanger in question can be equipped with means for cooling the refrigerant, for example with air or water. In particular, the gas cooler can be an air-cooled finned tube heat exchanger. In this case, the gas cooler can be particularly compact. The refrigerant flows from the gas cooler via the expansion valve, through which it becomes gaseous, steam or wet steam again due to expansion as a result of a pressure drop. In the process, it flows through the heat exchanger, which is cooled as a result. Here, the refrigerant absorbs heat from the test space via the heat exchanger. Subsequently, the gaseous refrigerant is aspirated and compressed again by the low-pressure compressor and the high-pressure compressor.

The term expansion valve refers at least to an expansion element, a throttle element, a throttle valve or another suitable constriction of a fluid conduit. The expansion valve and other valves of the cooling circuit are preferably controllable.

The present disclosure intends for the other cooling circuit of the cooling device to be coupled to the heat exchanger in the test space. The other refrigerant in the other cooling circuit is always separate from the refrigerant of the cooling circuit. The heat exchanger does not connect the respective cooling circuits. Hence, it is basically possible for the heat exchanger to form a first partial heat exchanger for the cooling circuit and a second partial heat exchanger for the other cooling circuit. These partial heat exchangers can also be disposed in separate places in the test space and then form the heat exchanger. The other cooling circuit has the other heat exchanger, which forms a gas cooler for the other refrigerant. The other refrigerant can then be compressed through the other compressor, cooled or liquefied in the other heat exchanger and be used to cool the heat exchanger via the other expansion valve. In this context, the other refrigerant of the other cooling circuit is different from the refrigerant of the cooling circuit. The other refrigerant can be selected in such a manner that the other refrigerant can be used to establish a temperature that is lower than the lowest temperature that could be established using the refrigerant. Overall, this makes it possible for comparatively low temperatures to be established using the test chamber without requiring particular changes to the cooling circuit. In this case, carbon dioxide, which is particularly environmentally friendly, can continue to be used as the refrigerant. The other cooling circuit can be of a particularly simple and compact design and have a comparatively less environmentally friendly refrigerant as the other refrigerant. The cooling circuit can then be operated for a major part of an operating time of the cooling device, whereas the other cooling circuit has to be operated only when comparatively low temperatures are to be achieved, which is typically not often the case. An amount of less environmentally friendly refrigerant of the cooling device can be reduced substantially in this manner. Since the other cooling circuit is operated as needed only, energy can be saved. Potentially required safety-related technical measures are necessary for a smaller part of the installation only, which reduces cost.

Another bypass with at least another valve and the other heat exchanger can be formed in the cooling circuit, in which case the other bypass can be connected to a high-pressure side downstream of the gas cooler and upstream of the expansion valve and to a low-pressure side downstream of the heat exchanger and upstream of the low-pressure compressor, refrigerant can be metered into the low-pressure side via the other valve, and the other refrigerant of the other cooling circuit can be cooled in the other heat exchanger. Accordingly, the cooling circuit can be used to cool the other heat exchanger or gas cooler of the other cooling circuit via the other bypass. The other valve can be an expansion valve or a simple throttle valve. A portion of a cold capacity of the cooling circuit can thus be used to condense, i.e., liquefy, the other refrigerant in order to operate the other cooling circuit. The cooling circuit can therefore be used particularly efficiently. In principal, however, it is also possible for the other heat exchanger to be cooled in another manner, e.g., by air or water.

A reservoir for the other refrigerant can be connected to the other cooling circuit, in which case the other refrigerant can be moved to the reservoir at a temperature in a temperature range of +50° C. to +180° C. within the test space. This also makes it possible for a comparatively less environmentally friendly refrigerant to be used as the other refrigerant. If the refrigerant is flammable or highly flammable, the other refrigerant can be moved into the reservoir entirely or for the major part so that there is no or only little other refrigerant in the heat exchanger. At higher temperatures in the test space, in particular, there is a risk that the other refrigerant leaks into the test space in the event of a leak of the heat exchanger or of the other cooling circuit within the test space, in which case an explosive mixture can form in the test space. When the other cooling circuit is not in operation, the other refrigerant can be moved to the reservoir so that additional safety-related technical features, such as sensors or the like, are unnecessary. The other refrigerant can be moved to the reservoir via the other compressor, additional valves or the like, for example. The reservoir can be a tank for holding the other refrigerant.

It can be intended for the other compressor to be operated at least at a temperature of <−50° C. within the test space. Operation of the respective compressors can be controlled by the control device. The cooling circuit can be operated up to the temperature of −50° C., the triple point of the carbon dioxide making it difficult to achieve lower temperatures. If lower temperatures need to be established in the test space, this can be achieved using the other cooling circuit with the other compressor. In this case, all compressors, i.e., the cooling circuit and the other cooling circuit, may be operated simultaneously.

The cooling circuit can have an internal heat exchanger, which can be connected to a high-pressure side of the cooling circuit downstream of the gas cooler and upstream of the expansion valve, and the internal heat exchanger can be coupled to a medium-pressure bypass of the cooling circuit, and the medium-pressure bypass can be connected to the high-pressure side downstream of the internal heat exchanger upstream of the gas cooler and upstream of the expansion valve and to a medium-pressure side of the cooling circuit upstream of the high-pressure compressor and downstream of the low-pressure compressor, and refrigerant can be metered from the high-pressure side into the medium-pressure side via the internal heat exchanger by means of another expansion valve. Immediately downstream of the internal heat exchanger and upstream of the expansion valve, the medium-pressure bypass with the other expansion valve can consequently be connected to the circuit. Refrigerant that has already passed through the internal heat exchanger can then also be fed and expanded via the other expansion valve. The internal heat exchanger can also be connected in the medium-pressure bypass downstream of the other expansion valve. The refrigerant expanded at the other expansion valve flows through the internal heat exchanger, which is cooled as a result. Consequently, the internal heat exchanger in the medium-pressure side and thus the refrigerant in the high-pressure side of the internal heat exchanger are cooled. In principle, however, the medium-pressure bypass can also be connected to the cooling circuit in such a manner downstream of the gas cooler and upstream of the internal heat exchanger that the refrigerant then flows via the further expansion valve and the internal heat exchanger. Downstream of the internal heat exchanger, the medium-pressure bypass can be connected between the low-pressure compressor and the high-pressure compressor in such a manner that the refrigerant routed via the medium-pressure bypass can be mixed with the refrigerant circulating in the cooling circuit in this location. By using the medium-pressure bypass with the internal heat exchanger, it is possible, depending on the cooling load requirement of the control device, to divert refrigerant via the medium-pressure bypass so that less refrigerant flows via the expansion valve. At the same time, the refrigerant flowing via the medium-pressure bypass can be used to temperature-control the refrigerant on the high-pressure side by means of the internal heat exchanger. The very high volumetric cooling capacity of the carbon dioxides is thus diverted upstream of the heat exchanger and used for cooling the refrigerant on the high-pressure side when less cooling capacity is required in the test space. This also makes it possible for the test space to be smaller and for the cooling circuit operated with carbon dioxide to be used for more compact test chambers.

Via the second expansion valve, refrigerant can be metered from the high-pressure side into the medium-pressure side via the internal heat exchanger in such a manner that the refrigerant becomes fully gaseous, i.e., decompressed, in the internal heat exchanger and/or the refrigerant located in the medium-pressure side is cooled. Thus, the compressed and highly superheated refrigerant can be cooled downstream of the low-pressure compressor. The second expansion valve can also cool the medium-pressure side of the internal heat exchanger in order to additionally cool transcritical refrigerant located on the high-pressure side of the internal heat exchanger. Furthermore, the comparatively cold refrigerant flowing via the medium-pressure bypass can then be introduced between the low-pressure compressor and the high-pressure compressor. When the low-pressure compressor is in operation, it transports refrigerant from a low-pressure side of the cooling circuit to the medium-pressure side, at which point the refrigerant can already have a very high temperature. This can cause thermal overload at the high-pressure compressor. This thermal overload can be avoided by admixing the comparatively colder refrigerant via the medium-pressure bypass.

The internal heat exchanger can be used to supercool the refrigerant of the high-pressure side. An enthalpy difference at the heat exchanger can be increased by this additional supercooling, which in turn leads to an increase in the cold capacity of the heat exchanger. This makes it possible for particularly low temperatures to be established efficiently in the test space.

Via the second expansion valve, refrigerant can be metered from the high-pressure side into the medium-pressure side in such a manner that a mass flow of refrigerant at the high-pressure compressor is always greater than a mass flow of refrigerant at the low-pressure compressor. If the refrigerant is supercooled by the internal heat exchanger, no dissipation occurs at the heat exchanger since the mass flow transported via the high-pressure compressor can be significantly greater than the mass flow transported via the low-pressure compressor. The reason for this is a significantly higher density of the refrigerant at an entry of the high-pressure compressor as compared to the density of the refrigerant at an entry of the low-pressure compressor. The mass flows in the cooling circuit can be described by the equation 0=m_{high-pressure compressor}−(m_{low-pressure compressor}+m_{internal heat exchanger}). Accordingly, the mass flow of the internal heat exchanger is the result of the difference between the mass flows of the high-pressure compressor and of the low-pressure compressor. The control device can be configured in such a manner that this ratio is maintained at all times through control of the second expansion valve. In this manner, a pressure drop on the medium-pressure side can be prevented. This pressure drop on the medium side could lead to a shift in a pressure ratio at the high-pressure compressor, which could cause the high-pressure compressor and/or the low-pressure compressor to exceed an intended use threshold, which is to be avoided.

For example, the second expansion valve can be controlled as a function of a pressure and/or a temperature of the refrigerants located in the medium-pressure side. The pressure and/or temperature can be measured using appropriate sensors. The second expansion valve can then be controlled by means of the control device or a regulating feature of the control device in such a manner that an intake temperature of the high-pressure compressor and/or a pressure on an inlet side of the high-pressure compressor is within a required range. In this manner, possible damage to the high-pressure compressor and/or the low-pressure compressor as a result of unsuitable temperatures and pressures can be avoided by simple means.

A pressure of the refrigerant on the high-pressure side can be reduced if the cooling circuit can be operated in a partial-load operating state. In a partial-load operating state, the cooling circuit is not operated at full load. Rather, the expansion valve opens intermittently, i.e., not permanently or completely, due to a decreasing cooling load requirement of the control device or of the test space. Since the refrigerant on the high-pressure side has a lower pressure, a final compression temperature of the high-pressure compressor can also be lower, which means that the amount of heat emitted via the gas cooler is reduced via an environment in which the test chamber is located. As a result, a thermal load on a test chamber installation room, which may or may not be air-conditioned, can be reduced. In the partial-load operating state, only a very low cold capacity is required, for example less than 2% of the cold capacity of the cooling circuit, and/or at temperatures in the test space of, for example, ≥−10° C. Since an output of the compressors can hardly be controlled, the lower cooling capacity is achieved by reducing the pressure of the refrigerant on the high-pressure side when a low cold capacity is required and/or when there is a small temperature difference between a target temperature and an actual temperature in the test space, without having to immediately switch off the compressors. In this manner, frequent start-up intervals for the low-pressure compressor and the high-pressure compressor can be avoided, which is why the compressors can be operated with a long service life.

A high-pressure valve of the cooling circuit disposed downstream of the gas cooler can be used to meter gaseous and/or liquid refrigerant into a storage tank for refrigerant; the storage tank can be connected to a medium-pressure side of the cooling circuit upstream of the high-pressure compressor and downstream of the low-pressure compressor via a medium-pressure bypass of the cooling circuit, and a medium-pressure valve can be used to meter gaseous refrigerant from the storage tank into the medium-pressure side when the low-pressure compressor is switched off. Depending on the extraction point on the storage tank, liquid or gaseous refrigerant can be tapped from the storage tank. The liquid refrigerant can be passed on via the expansion valve, where it can return to a gaseous state through expansion as a result of a pressure drop. In doing so, it flows through the heat exchanger, which is cooled as a result. In this embodiment of the cooling circuit, it may be provided that the high-pressure valve is disposed downstream of the gas cooler in the cooling circuit in order to meter gaseous and/or liquid refrigerant into the storage tank via the high-pressure valve. The storage tank is essentially a pressure vessel in which, when a phase boundary is formed, the liquid refrigerant is stored in a lower area and the gaseous refrigerant is stored in an upper area of the pressure vessel. Depending on the extraction point, liquid or gaseous refrigerant can be extracted from the storage tank. Thus, liquid refrigerant can be supplied to the expansion valve and be decompressed therein so as to cool the heat exchanger.

The cooling circuit can be operated in a thermodynamically subcritical or transcritical operating state. Depending on the cooling load requirement within the test space, the operating state can be changed accordingly using the control device. In subcritical operation of the cooling circuit, the refrigerant is liquefied in the gas cooler below the critical point of the refrigerant and expanded at the expansion valve and converted to the gaseous phase or wet steam. The high-pressure compressor and the low-pressure compressor can be operated at least in the subcritical operating state or at low ambient temperatures. The subcritical operating state of the cooling circuit corresponds to partial load operation. In the transcritical operating state, the refrigerant circulates in the cooling circuit essentially in a gaseous state. This means that a difference in temperature is reduced to such an extent that the refrigerant is not liquefied in the gas cooler. Also, a pressure above the critical point of the refrigerant is reached at the gas cooler in the transcritical operating state. If there is a high cooling load requirement or cooling from +180° C. to −20° C. is required, for example, the cooling circuit can be operated transcritically. If there is a low cooling load requirement within the test space, for example if a temperature is to be kept constant, or if ambient temperatures are low, the cooling circuit can be operated subcritically. This allows an increase in efficiency to be achieved in particular in the case of low cooling load requirements, e.g., at low ambient temperatures, in contrast to exclusively transcritical operating states. The change between the subcritical and the transcritical operating state is made possible in particular by the medium-pressure bypass and the internal heat exchanger.

A second bypass with at least a third expansion valve can be formed in the cooling circuit, and the second bypass can be connected to a high-pressure side downstream of an internal heat exchanger or the gas cooler and upstream of the expansion valve and to a low-pressure side downstream of the heat exchanger and upstream of the low-pressure compressor, and a suction-gas temperature and/or a suction-gas pressure of the refrigerant on the low-pressure side of the cooling circuit upstream of the low-pressure compressor can be controlled by metering refrigerant into the low-pressure side via the third expansion valve. The third expansion valve can be used to influence the suction-gas temperature and/or the suction-gas pressure upstream of the low-pressure compressor in such a manner that a final compression temperature of the low-pressure compressor is within an operating range intended for the low-pressure compressor. For example, a suction-gas temperature of the low-pressure compressor can rise particularly sharply if a temperature in the test space is to be reduced, for example, from +180° C. to a lower temperature. Since the heat exchanger is located in the test space, the refrigerant, at particularly high temperatures in the test space of +180° C., for example, can flow from the heat exchanger to the low-pressure compressor at this temperature. Before the heavily overheated refrigerant is fed to the low-pressure compressor, it can be cooled by the refrigerant metered via the third expansion valve.

A control bypass having at least one control valve may be formed in the cooling circuit, and the control bypass may be connected to a high-pressure side downstream of the high-pressure compressor and upstream of the gas cooler and to a low-pressure side downstream of the heat exchanger and upstream of the low-pressure compressor, and a suction-gas temperature and/or a suction-gas pressure of the refrigerant on the low-pressure side of the cooling circuit upstream of the low-pressure compressor can be controlled and/or a difference in pressure between the high-pressure side and the low-pressure side of the cooling circuit can be equalized by metering refrigerant into the low-pressure side via the control valve. Accordingly, the control bypass is configured in such a manner that refrigerant can be fed from the high-pressure side to the low-pressure side via the control valve. The refrigerant can be superheated or gaseous. Returning superheated refrigerant from the high-pressure side to the low-pressure side by means of the control bypass is advantageous in particular if the cooling circuit is operated in a partial-load operating state. As the expansion valve is opened rarely in this case, there is a risk that a suction pressure upstream of the low-pressure compressor drops too far. When using carbon dioxide as the refrigerant, dry ice can form at a pressure below 5.16 bar absolute, which could disrupt safe operation of the cooling circuit and possibly damage the low-pressure compressor. As highly superheated refrigerant can be fed directly downstream of the high-pressure compressor to a point upstream of the low-pressure compressor via the control bypass, the formation of dry ice can be effectively prevented. In addition, it is also possible to equalize a difference in pressure between the high-pressure side and the low-pressure side of the cooling circuit via the control bypass, for example when the cooling device is not in operation and there is a risk that refrigerant will be heated as a result of temperature equalization with an environment and an undesirably high pressure will build up in the cooling circuit.

A dehumidifier bypass of the cooling circuit comprising a dehumidifier valve and a second heat exchanger in the test space can be used to dehumidify air in the test space. This dehumidification can take place at a certain point during a test cycle, in particular whenever a temperature in the test space is within a range of >0 to <100° C. If a temperature within the test space is below or above this range, no water can precipitate on the second heat exchanger in the liquid phase, so the dehumidifier bypass does not function in these ranges. Accordingly, the cooling circuit of the cooling device can be designed in such a manner that the temperature of −20° C. to +180° C. can be established within the test space during a test cycle, and dehumidification of the air by means of the dehumidifier bypass can be carried out only in a partial range of this temperature range. Dehumidification takes place by metering the refrigerant from a high-pressure side of the cooling circuit into a low-pressure side of the cooling circuit via the dehumidifier valve. This results in cooling of the second heat exchanger, which is disposed downstream of the dehumidifier valve in a flow direction of the refrigerant in the dehumidifier bypass. The control device can now meter the refrigerant via the dehumidifier valve in such a manner that a desired difference in temperature between the temperature of the air in the test space and the temperature of the second heat exchanger is achieved. This difference in temperature can be selected in such a manner that water from the air in the test space condenses on the second heat exchanger. This makes it possible for targeted dehumidification of the air of the test space to be carried out essentially independently of a temperature established in the test space. The expansion valve and the dehumidifier valve can thus be controlled independently of each other using the control device. A lowering of a temperature in the test space can then be accompanied, for example, by more or less dehumidification, whereby a relative humidity can be set or controlled more precisely. Overall, a climatic test cycle can be carried out much more accurately with just a few components in a compact test chamber.

The dehumidifier bypass can be connected to a high-pressure side of the cooling circuit downstream of the gas cooler and upstream of the expansion valve and to a low-pressure side of the cooling circuit downstream of the heat exchanger and upstream of the low-pressure compressor, and refrigerant can be metered from the high-pressure side into the low-pressure side via the dehumidifier valve in such a manner that the second heat exchanger is cooled. The dehumidifier valve can be an electronic expansion valve or a solenoid valve with a downstream throttle, for example through a capillary tube, a nozzle or the like, or a thermostatic expansion valve. Optionally, the dehumidifier bypass may also be connected downstream of any internal heat exchanger downstream of the gas cooler. The dehumidifier bypass can therefore be connected to the cooling circuit in parallel with the expansion valve and the heat exchanger. In this manner, the dehumidifier bypass can be of a particularly simple design.

Non-fluorinated refrigerant, preferably pure carbon dioxide, can be used as the refrigerant in the cooling circuit, and/or R469A can be used as the other refrigerant in the other cooling circuit. Pure carbon dioxide has a GWP of 1, is non-flammable, non-hazardous and available at low cost. In addition, carbon dioxide is a pure substance or azeotropic, which is what makes the advantageous implementation of the method and its variations possible in the first place. A refrigerant with zeotropic behavior, on the other hand, would hardly make it possible to provide a sufficient quantity of gaseous refrigerant at a very low difference in temperature and thus hardly allow for performance control of the high-pressure compressor. R469A is a comparatively environmentally friendly refrigerant, which has a comparatively low GWP and is nonflammable due to the high carbon dioxide content. In particular, the other refrigerant allows temperatures of up to −80° C. to be established in the test space or at the heat exchanger.

The temperature control device can be used to establish a temperature in a temperature range of −50° C. to +180° C., preferably −80° C. to +180° C., particularly preferably −90° C. to +180° C., within the test space.

The test chamber according to the disclosure, in particular a climate chamber, for conditioning air comprises a test space for receiving test material, the test space being configured to be sealed from an environment and temperature-insulated, and a temperature control device for controlling the temperature of the test space, the temperature control device being configured to establish a temperature in a temperature range of −20° C. to +180° C. within the test space, the temperature control device comprising a cooling device with a cooling circuit with carbon dioxide as a refrigerant, a heat exchanger in the test space, a low-pressure compressor and a high-pressure compressor, a gas cooler, and an expansion valve downstream of the low-pressure compressor in a flow direction of the refrigerant, the test chamber comprising a control device for controlling the temperature in the test space, wherein the cooling device comprises another cooling circuit with another refrigerant, the heat exchanger in the test space, another compressor, another heat exchanger and another expansion valve. Regarding the advantages of the test chamber according to the disclosure, reference is made to the description of advantages of the method according to the disclosure.

The temperature control device can have a heating device with a heater and a heating heat exchanger in the test space. For example, the heating device can be an electrical resistance heater that heats the heating heat exchanger in such a manner that an increase in temperature in the test space is made possible via the heating heat exchanger. If the heat exchanger and the heating heat exchanger can be controlled in a targeted manner by means of the control device to cool or heat the air circulated in the test space, a temperature in the temperature ranges specified above can then be established within the test space by means of the temperature control device.

The low-pressure compressor and the high-pressure compressor can share a housing. Furthermore, the low-pressure compressor and the high-pressure compressor can be driven by a shared, i.e., the same, motor. The cooling device can be of a particularly compact design in this case.

Other embodiments of a test chamber are apparent from the descriptions of features of the method.

Hereinafter, a preferred embodiment of the invention is explained in more detail with reference to the accompanying drawings.

### BRIEF DESCRIPTION OF THE FIGURES

FIG. 1 is a schematic illustration of a cooling device.

FIG. 2 is a pressure-enthalpy diagram with an operating state of a cooling circuit.

### DETAILED DESCRIPTION

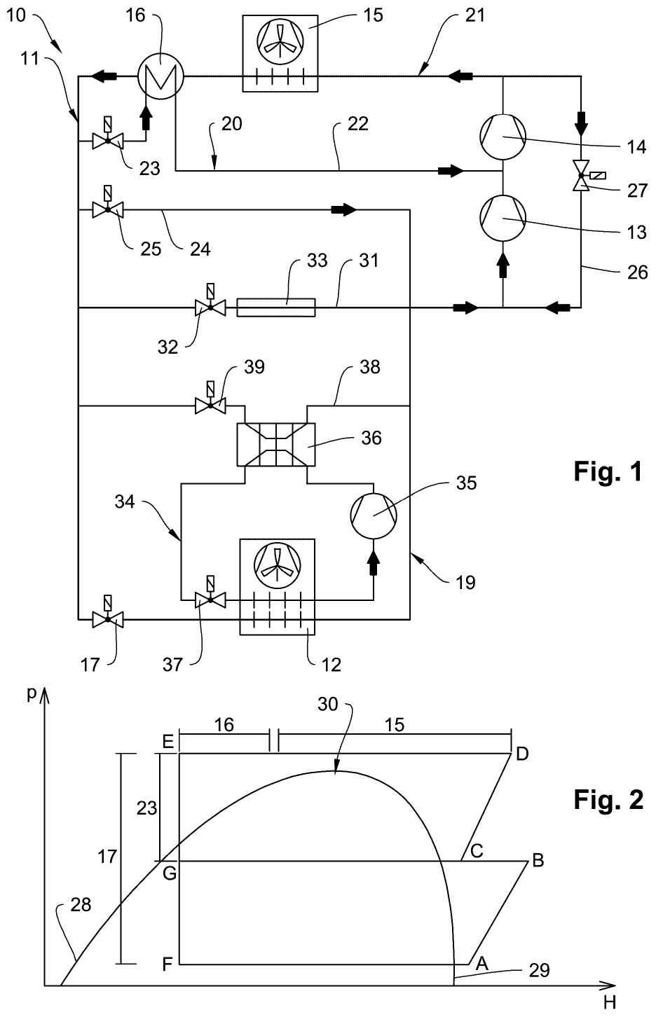

FIG. 1 shows a possible embodiment of a cooling device 10 of a test chamber (not shown). The cooling device 10 comprises a cooling circuit 11 with carbon dioxide (CO₂) as a refrigerant, a heat exchanger 12, a low-pressure compressor 13, a high-pressure compressor 14, a gas cooler 15, an internal heat exchanger 16, and an expansion valve 17. In the case at hand, the gas cooler 15 is configured in the manner of a heat exchanger or condenser and is cooled by a heat transfer medium, such as air or water. The heat exchanger 12 is disposed in an air treatment duct (not shown) of the test space of the test chamber in such a manner that air in the test space, which is circulated via the air treatment duct, can be cooled by means of the heat exchanger 12. Furthermore, the cooling circuit 11 has a low-pressure side 19, a medium-pressure side 20 and a high-pressure side 21. In the low-pressure side 19, the pressure of the refrigerant is comparatively lower than in the medium-pressure side 20. In the medium-pressure side 20, the pressure of the refrigerant is comparatively lower than in the high-pressure side 21.

The cooling circuit 11 further has the internal heat exchanger 16 downstream in a flow direction of the refrigerant and a medium-pressure bypass 22 upstream of the expansion valve 17, the medium-pressure bypass 22 ending downstream of the low-pressure compressor 13 and upstream of the high-pressure compressor 14. A second expansion valve 23 is disposed in the medium-pressure bypass 22. The second expansion valve 23 is connected upstream of the internal heat exchanger 16. Essentially liquid refrigerant can now be fed from the gas cooler 15 through the high-pressure side 21 of the internal heat exchanger 16 and, if required, metered into the medium-pressure side 20 of the internal heat exchanger 16 via the second expansion valve 23. In this process, the refrigerant of the high-pressure side 21 is subcooled to such an extent that an even lower temperature can be established at the expansion valve 17 or the heat exchanger 12. At the same time, the refrigerant flowing via the medium-pressure bypass 22 can be used to keep the suction-gas temperature of the high-pressure compressor 14 comparatively low.

In addition, the cooling circuit 11 comprises a second bypass 24 with a third expansion valve 25. The second bypass 24 is connected to the cooling circuit 11 downstream of the internal heat exchanger 16 and upstream of the expansion valve 17 and downstream of the heat exchanger 14 and upstream of the low-pressure compressor 13 in the flow direction of the refrigerant. By means of the third expansion valve 25, liquid refrigerant can be fed to the low-pressure side 19 past the expansion valve 17 and the heat exchanger 12. This makes it possible to control a suction-gas temperature and/or a suction-gas pressure in the low-pressure side 19 upstream of the low-pressure compressor 13.

Furthermore, the cooling circuit 11 comprises a control bypass 26 with a control valve 27, the control bypass 26 being connected to the cooling circuit 11 downstream of the high-pressure compressor 14 and upstream of the gas cooler 15 and downstream of the heat exchanger 12 and upstream of the low-pressure compressor 13 in the flow direction of the refrigerant. By means of the control bypass 26 or the control valve 27, refrigerant, in particular superheated refrigerant or gaseous refrigerant, can be fed from the high-pressure side 21 to the low-pressure side 19 upstream of the low-pressure compressor 13 as a function of an operating state of the cooling circuit 11. This also makes it possible to control a suction-gas temperature and/or a suction-gas pressure of the low-pressure side 19 upstream of the low-pressure compressor 13. Said control can take place by means of a control device (not shown) of the test chamber and sensors located in the cooling circuit 11, in particular pressure and temperature sensors.

FIG. 2 shows a pressure-enthalpy diagram (log-p-h diagram) for the refrigerant circulating in the cooling circuit 11 for an operating state of the cooling circuit 11 when the low-pressure compressor 13 and the high-pressure compressor 14 are being operated. In the diagram, the specific enthalpy is shown on the abscissa axis and the logarithmically scaled pressure is shown on the ordinate axis. A boiling line 28 marks a transition from saturated liquid to wet steam, a dew line 29 marking a transition from wet steam to saturated steam. The boiling line 28 and the dew line 29 meet at the critical point 30.

FIG. 2 shows a supercritical operating state of the cooling circuit 11, in which, starting from position A, the refrigerant is taken in by the low-pressure side 19 with the low-pressure compressor 13 and compressed, causing a pressure corresponding to position B downstream of the low-pressure compressor 13 to be reached. The refrigerant is then taken in by the high-pressure compressor 14 downstream of position C and compressed up to position D. As a result, the refrigerant flows through the gas cooler 15 in the transcritical state and is liquefied or desuperheated. After that, the refrigerant passes through the internal heat exchanger 16 and to position E. Part of the liquid refrigerant flows through the expansion valve 17, where the refrigerant expands (positions E to F), the refrigerant evaporating in the heat exchanger 12 (positions F to A). Another part of the refrigerants flows through the medium-pressure bypass 22, where the refrigerant also expands in the second expansion valve 23 (positions E to G), the refrigerant evaporating in the internal heat exchanger 16 (positions G to C). In position C, the refrigerant from the medium-pressure bypass 22 mixes with the refrigerant from the low-pressure compressor 13.

Furthermore, a dehumidifier bypass 31 with a dehumidifier valve 32 and a second heat exchanger 22, which is also located in the test space, is disposed in the cooling circuit 11. Air in the test space can be dehumidified by means of the second heat exchanger 33 or the dehumidifier bypass 31. For this purpose, the test chamber has a control device (not shown) with which a temperature and/or a relative humidity in the test space can be controlled. To this end, the control device can actuate the expansion valve 17 and the second expansion valve 23 in particular. This makes it possible for the cooling device 10 to be used to carry out climatic tests in which dehumidification or relative humidity in the test space can be established very accurately even at a constant or falling temperature in the test space.

Moreover, the cooling device 10 comprises another cooling circuit 34 with another refrigerant, the heat exchanger 12, another compressor 35, another heat exchanger 36 and another expansion valve 37. R469A is used here as the other refrigerant. Alternatively, a refrigerant based on carbon dioxide or a flammable refrigerant can be used as the other refrigerant. The other cooling circuit 34 is used for additional cooling of the test space via the heat exchanger 12.

Another bypass 38 with another valve 39 is formed in the cooling circuit 11. The other bypass 38 runs via the other heat exchanger 36 and is connected to the high-pressure side 21 downstream of the gas cooler 15 and upstream of the expansion valve 17 and to the low-pressure side 19 downstream of the heat exchanger 12 and upstream of the low-pressure compressor 13. The other valve 39 can now be used to meter refrigerant into the low-pressure side 19 or into the other heat exchanger 36. This cools the other refrigerant of the other cooling circuit 34 in the other heat exchanger 36 and liquefies it by condensation. The other cooling circuit 34 can then be put into operation when a temperature below −50° C. is to be established in the test space. This makes it possible for a temperature of up to −80° C. to be established in the test space.

1. A method for conditioning air in a test space of a test chamber, in particular a climate chamber, for receiving test material, the test space being configured to be sealed from an environment and temperature-insulated, a cooling device of a temperature control device of the test chamber, which comprises a cooling circuit with carbon dioxide (CO₂) as a refrigerant, a heat exchanger in the test space, a low-pressure compressor, and a high-pressure compressor, a gas cooler, and an expansion valve downstream of the low-pressure compressor in a flow direction of the refrigerant, being used to establish a temperature in a temperature range of −20° C. to +180° C. within the test space, a control device of the test chamber being used to control the temperature in the test space,
wherein
another cooling circuit of the cooling device with another refrigerant, the heat exchanger in the test space, another compressor, another heat exchanger and another expansion valve is used to establish the temperature within the test space.

2. The method according to claim 1,
wherein
another bypass with at least one other valve and the other heat exchanger is formed in the cooling circuit, the other bypass being connected to a high-pressure side downstream of the gas cooler and upstream of the expansion valve and to a low-pressure side downstream of the heat exchanger and upstream of the low-pressure compressor, refrigerant being metered into the low-pressure side via the other valve, and the other refrigerant of the other cooling circuit being cooled in the other heat exchanger.

3. The method according to claim 1,
wherein
a reservoir for the other refrigerant is connected to the other cooling circuit, the other refrigerant being moved to the reservoir when a temperature within the test space is in a temperature range of +50° C. to +180° C.

4. The method according to claim 1,
wherein
the other compressor is operated at least at a temperature of <−50° C. within the test space.

5. The method according to claim 1,
wherein
the cooling circuit has an internal heat exchanger connected to a high-pressure side of the cooling circuit downstream of the gas cooler and upstream of the expansion valve, the internal heat exchanger being coupled to a medium-pressure bypass of the cooling circuit, the medium-pressure bypass being connected to the high-pressure side downstream of the internal heat exchanger or the gas cooler and upstream of the expansion valve and to a medium-pressure side of the cooling circuit upstream of the high-pressure compressor and downstream of the low-pressure compressor, a second expansion valve being used to meter refrigerant from the high-pressure side into the medium-pressure side via the internal heat exchanger.

6. The method according to claim 5,
wherein
via the second expansion valve, refrigerant is metered from the high-pressure side into the medium-pressure side via the internal heat exchanger in such a manner that the refrigerant becomes fully gaseous in the internal heat exchanger and/or the refrigerant located in the medium-pressure side is cooled.

7. The method according to claim 5,
wherein
the internal heat exchanger is used to supercool the refrigerant of the high-pressure side.

8. The method according to claim 5,
wherein
refrigerant is metered from the high-pressure side into the medium-pressure side via the second expansion valve in such a manner that a mass flow of refrigerant at the high-pressure compressor is always greater than a mass flow of refrigerant at the low-pressure compressor.

9. The method according to claim 5,
wherein
the second expansion valve is controlled as a function of a pressure and/or a temperature of the refrigerant located in the medium-pressure side.

10. The method according to claim 1,
wherein
a high-pressure valve of the cooling circuit disposed downstream of the gas cooler is used to meter gaseous and/or liquid refrigerant into a storage tank for refrigerant, the storage tank being connected to a medium-pressure side of the cooling circuit upstream of the high-pressure compressor and downstream of the low-pressure compressor via a medium-pressure bypass of the cooling circuit, a medium-pressure valve being used to meter gaseous refrigerant from the storage tank into the medium-pressure side when the low-pressure compressor is shut off.

11. The method according to claim 1,
wherein
the cooling circuit is operated in a thermodynamically subcritical or transcritical operating state.

12. The method according to claim 1,
wherein
a second bypass with at least a third expansion valve is formed in the cooling circuit, the second bypass being connected to a high-pressure side downstream of an internal heat exchanger or the gas cooler and upstream of the expansion valve and to a low-pressure side downstream of the heat exchanger and upstream of the low-pressure compressor, a suction-gas temperature and/or a suction-gas pressure of the refrigerant on the low-pressure side of the cooling circuit upstream of the low-pressure compressor being controlled by metering refrigerant into the low-pressure side via the third expansion valve.

13. The method according to claim 1,
wherein
control bypass having at least one control valve is formed in the cooling circuit, the control bypass being connected to a high-pressure side downstream of the high-pressure compressor and upstream of the gas cooler and to a low-pressure side downstream of the heat exchanger and upstream of the low-pressure compressor, a suction-gas temperature and/or a suction-gas pressure of the refrigerant on the low-pressure side of the cooling circuit upstream of the low-pressure compressor being controlled and/or a difference in pressure between the high-pressure side and the low-pressure side of the cooling circuit being equalized by metering refrigerant into the low-pressure side via the control valve.

14. The method according to claim 1,
wherein
a dehumidifier bypass of the cooling circuit, which comprises a dehumidifier valve and a second heat exchanger in the test space, is used to dehumidify air in the test space.

15. The method according to claim 14,
wherein
the dehumidifier bypass is connected to a high-pressure side of the cooling circuit downstream of the gas cooler and upstream of the expansion valve and to a low-pressure side of the cooling circuit downstream of the heat exchanger and upstream of the low-pressure compressor, refrigerant being metered from the high-pressure side into the low-pressure side via the dehumidifier valve in such a manner that the second heat exchanger is cooled.

16. The method according to claim 1,
wherein
a non-fluorinated refrigerant is used as the refrigerant in the cooling circuit, and/or R469A is used as the other refrigerant in the other cooling circuit.

17. The method according to claim 1,
wherein
the temperature control device is used to establish a temperature in a temperature range of −50° C. to +180° C., within the test space.

18. A test chamber, in particular a climate chamber, for conditioning air, the test chamber comprising a test space for receiving test material, the test space being configured to be sealed from an environment and temperature-insulated, and a temperature control device for controlling the temperature of the test space, the temperature control device being configured to establish a temperature in a temperature range of −20° C. to +180° C. within the test space, the temperature control device comprising a cooling device with a cooling circuit with carbon dioxide as a refrigerant, a heat exchanger in the test space, a low-pressure compressor, and a high-pressure compressor, a gas cooler, and an expansion valve downstream of the low-pressure compressor in a flow direction of the refrigerant, the test chamber comprising a control device for controlling the temperature in the test space,
wherein
the cooling device comprises another cooling circuit with another refrigerant, the heat exchanger in the test space, another compressor, another heat exchanger and another expansion valve.

19. The test chamber according to claim 18,
wherein
the temperature control device comprises a heating device having a heater and a heating heat exchanger in the test space.

20. The method according to claim 16,
wherein
the non-fluorinated refrigerant is pure carbon dioxide (CO₂).
